(19) United States
(12) Patent Application Publication
(10) Pub. No.: US 2003/0048846 A1
(43) Pub. Date: Mar. 13, 2003

(54) Motion image compression apparatus capable of varying frame rate and method of compressing motion image using the same

(76) Inventor: Myeong-Hwan Lee, Seoul (KR)

Correspondence Address: CANTOR COLBURN, LLP, 55 GRIFFIN ROAD SOUTH, BLOOMFIELD, CT, 06002

(21) Appl. No.: 10/208,477

(22) Filed: Jul. 30, 2002

(30) Foreign Application Priority Data
Jul. 31, 2001 (KR) 2001-46356
Jul. 19, 2002 (KR) 2002-42677

(51) Int. Cl. H04N 7/12

(52) U.S. Cl. 375/240.12; 375/240.01

(57) ABSTRACT

A motion image compression apparatus capable of changing frame rate, including a compression section for compressing motion images using a prediction technique after receiving the motion images frame by frame, and a preprocessing section located at a front end of the compression section for receiving original motion images, changing a frame rate of the original motion images to a desired frame rate and sending the motion images having the desired frame rate to the compression section frame by frame.

### BACKGROUND OF THE INVENTION

1. Field of the Invention

The present invention relates to an apparatus and a method for compressing motion image, more particularly to an apparatus and method for compressing motion image capable of changing frame rate (the number of frames displayed per second) during compressing the motion image.

2. Description of Related Art

Generally, a motion image is compressed at a constant frame rate. For example, in accordance with the Moving Picture Experts Group (MPEG) standard, the moving picture is compressed at a rate of 30 frames (60 fields)/sec and 25 frames (50 fields)/sec for complying with the National Television Systems Committee (NTSC) standard and PAL standard, respectively.

The frame rate is forced to be fixed in compression process due to the broadcasting service standard such as NTSC and PAL as well as video image signals received from the camera or TV broadcasting service with the constant frame rate.

Compressing motion image at high frame rate as fast as the frame rate of video signals has an advantage of being able to respond to high speed motion image excellently thereby providing natural image of motion picture, but on the other hand has a drawback of requiring large storage capacity to store compressed data.

Accordingly, an application field that deals with slow motion image or requires saving of storage medium space does not need such high frame rate for compressing the motion image.

For example, a security application that requires continuously store images for a long time needs high frame rate only at emergency to respond to the fast movement but usually does not need such high frame rate. Storing images at low frame rate at a regular interval is usually enough respond to the security application.

The low frame rate allows the storage medium to store more amount of images, and can be usefully applied to the security application field. Further, the low frame rate is able to provide fluid image as much as the high frame rate in case of compressing original images (uncompressed images) at a regular interval.

Accordingly, changing the frame rate during compressing may be useful depending on the application field.

Generally data compression section in accordance with H.263 or MPEG standard encodes a moving picture based on discrete cosine transform (DCT) to remove spatial redundancy using a prediction technique to avoid temporal redundancy and supports an intra frame and an inter frame methods.

Further, by compressing the motion image according to the MPEG and H.263, compressed image data comprising intra frames (hereinafter referred to I frame) and predicted frames (hereinafter referred to P frame or inter frame) that reduce correlation of images by forward prediction is produced.

Intra frame method encodes a motion image frame by frame independently from an adjacent frame based on the DCT and the inter frame method encodes a motion image by predicting a current frame from a preceding frame. That is, the inter frame method generates compressed image data by distracting difference between the preceding frame and the current frame.

Further, interpolated frame (hereinafter referred to B frame) method that reduces correlation of images using bidirectional prediction is used for encoding in accordance with the MPEG standard.

A term “frame” in here means a term of “frame” used in broadcasting method. The term “frame” further designates a term “picture” that is usually used in moving picture compression standard such as MPEG.

In addition, the term “frame” designates a term “field” when the moving picture compression section uses field for compressing instead of frame. Accordingly, the term “frame”, “picture” and “field” designate the same element in this application.

For convenience' sake of explanation, all description hereinafter is related to I frame and P frame. Description related to B frame is omitted. As shown in FIG. 1, the original images are inputted into the compression section 10 at a frame rate M and encoded therein, so that shown in FIG. 2, compressed data comprising of I frames and P frames is output at a frame rate N therefrom.

Referring to FIG. 2, characters “A”, “B”, “C”, “ . . . ” in a first row designate frames comprising the original motion images (uncompressed images) and characters “I” and “P” in a second row designate the intra frame and the inter frame, respectively. As shown in FIG. 2, when one unit of the compressed data comprises one I frame and three P frames, the number of the frames (four in FIG. 2) comprising one unit of the compressed data is called a group of picture (GOP). Therefore, as the GOP becomes larger, compressibility becomes higher but precision of restored image is degraded.

The P frame that removes temporal redundancy has a small data size in comparison with the I frame. However, when the PB frame is restored, a preceding frame I_{A} of the P_{B} frame is used. Further, when the P_{C} frame is restored, preceding frames I_{A}, P_{B} are used. Therefore, preceding I frames and P frames must be used to restore a subsequent P frame.

Therefore, if an interposed P frame is removed to change the frame rate, it is impossible to restore the P frame subsequent to the removed P frame. Accordingly, changing the frame rate of the compressed data is very difficult.

### SUMMARY OF THE INVENTION

The invention provides an apparatus and a method for compressing motion image capable of changing frame rate without modifying compression section in the motion image compression apparatus.

The invention further provides an apparatus and a method for compressing motion image capable of changing frame rate without distortion of operation or performance of the compression section by down sampling original images inputted into the compression section or compressed data output from the compression section.

In one embodiment of the invention, there is provided a motion image compression apparatus capable of changing frame rate comprising a compression section for compressing motion images using a prediction technique after receiving the motion images frame by frame; and a preprocessing section locatd at the front end of the compression section for receiving original motion images, changing a frame rate of the original motion images to a desired frame rate and sending the motion images having the desired frame rate to the compression section frame by frame.

The motion image compression apparatus further comprises a multiple image dividing section located at the front end of the preprocessing section for dividing a multiple input motion image into a plurality of original motion images channel by channel and sending the devided original motion images to the preprocessing section when the multiple input motion image is received therein.

In another embodiment of the invention, there is provided a motion image compression apparatus capable of chaning frame rate, comprising a compression section for receiving original motion image frame by frame and compressing the original motion image using a prediction technique; and a preprocessing section located at the front end of the compression section for controlling a system clock of the compression section so that the original motion image is down sampled at a desired frame rate and then the down sampled image is inputted into the compression section when the original moving information is inputted into the compression section frame by frame.

In still another embodiment of the invention, there is provided a method of compressing motion image capable of chaning frame rate, comprising, preprocessing original motion image for outputing the original motion image frame by frame after changing frame rate of the original motion image to a desired frame rate; and compressing motion image having the desired frame rate frame by frame using a prediction technique.

In a further embodiment of the invention, there is provided a method of compressing a motion image capable of chaning frame rate, comprising: generating a control signal for controlling a clock signal which is used for receiving the motion image to be compressed; downsampling the motion image in response to the clock signal at a desired frame rate when the motion image is inputted; and compressing the down sampled motion image and outputting compressed data.

These and other aspects, factors, and advantages of the invention will become apparent from the following detailed description of preferred embodiments, which is to be read in conjunction with the accompanying drawings.

### BRIEF DESCRIPTION OF THE DRAWINGS

FIG. 1 is a block diagram of a motion image compression apparatus in accordance with the conventional art;

FIG. 2 is showing a sequence of encoding motion image in accordance with the conventional art;

FIG. 3 is a block diagram of a motion image compression apparatus capable of varying frame rate in accordance with one embodiment of the present invention;

FIG. 4 is showing a sequence of compressing motion image using the apparatus shown in FIG. 3 in accordance with a preferred embodiment of the present invention;

FIG. 5 is a block diagram of a motion image compression apparatus capable of varying frame rate in accordance with another embodiment of the present invention;

FIG. 6 is showing a sequence of compressing motion image using the motion image compression apparatus shown in FIG. 5, wherein a frame rate of each of a plurality of motion images is the same as each other;

FIG. 7 is showing a sequence of compressing motion image using the motion image compression apparatus shown in FIG. 6, wherein a frame rate of each of a plurality of motion images is different from each other;

FIG. 8 is a block diagram of a motion image compression apparatus capable of varying frame rate in accordance with further another embodiment of the present invention;

FIG. 9 is showing a sequence of compressing motion image using the motion image compression apparatus shown in FIG. 8;

FIG. 10 is a block diagram of a motion image compression apparatus capable of varying frame rate in accordance with still another embodiment of the present invention;

FIG. 11 is a block diagram of a motion image compression apparatus capable of varying frame rate in accordance with still further another embodiment of the present invention;

FIG. 12 is showing a sequence of compressing motion image using intra frame in the motion image compression apparatus shown in FIG. 11; and

FIG. 13 is showing a sequence of compressing motion image using inter frame and inter frame in the motion image compression apparatus shown in FIG. 11.

### DETAILED DESCRIPTION OF PREFFERED EMBODIMENTS

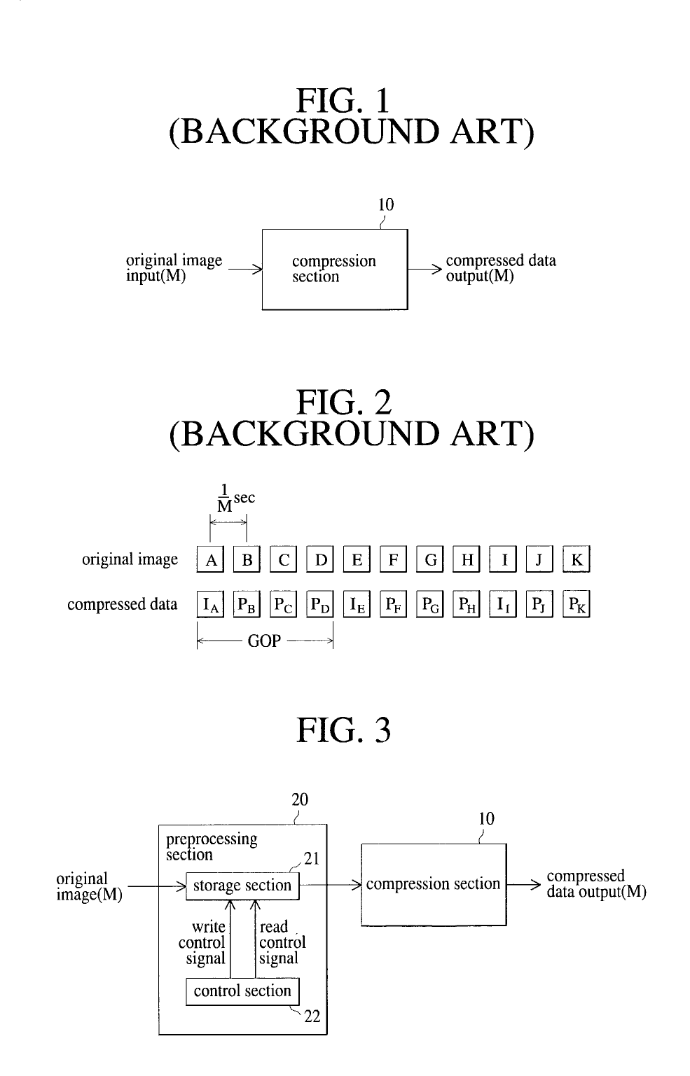

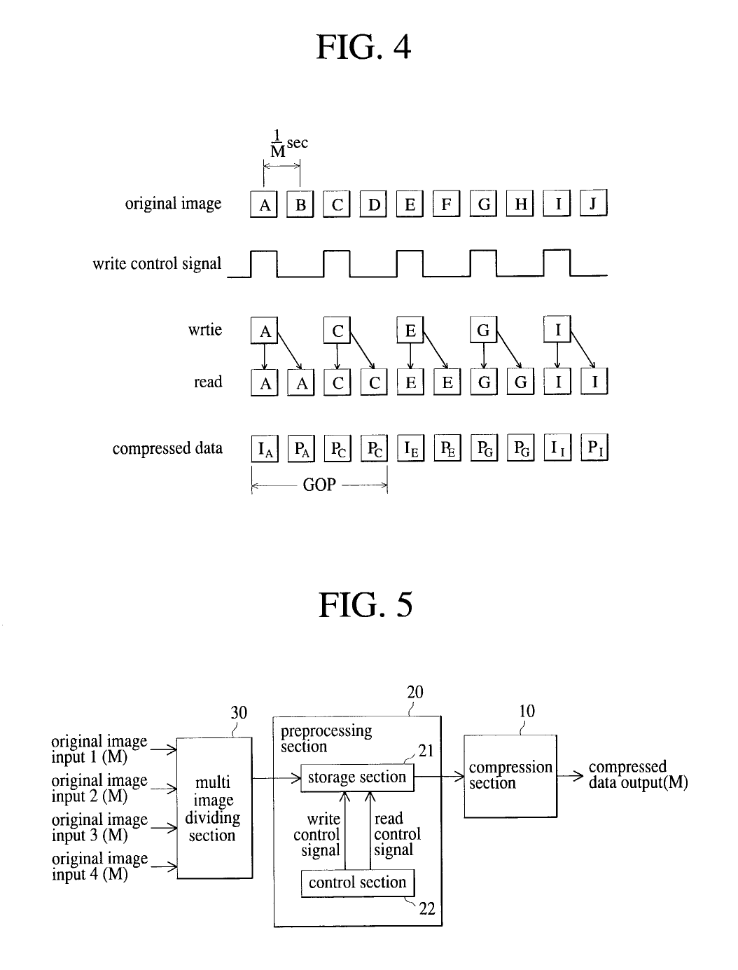

FIG. 3 is a block diagram of a motion image compression apparatus capable of changing frame rate in accordance with one preferred embodiment of the present invention and FIG. 4 is showing a sequence of compressing the motion image using the apparatus shown in FIG. 3.

As shown in FIG. 3, the motion image compression apparatus in accordance with an embodiment of the present invention comprises a preprocessing section 20 for changing frame rate of inputted original motion image to a desired frame rate and storing the motion image with the desired frame rate, and a compression section 10 for reading the motion image stored in the compression section at the desired frame rate, compressing the motion image and outputting compressed data.

The preprocessing section 20 may comprise a storage section 21 for temporally storing the inputted original motion image and a control section 22 for generating a read control signal and a write control signal and sending the same to the storage section 21.

When the original image is inputted into the preprocessing section 20 at a frame rate of M and a desired frame rate is N, the control section 22 generates the write control signal and transmits the same to the storage section 21, so that the original motion image is written into the storage section 21 at an interval of M/N frames in response to the write control signal. And then, the control section 22 generates the read control signal and transmits the same to the storage section 21, so that the motion image written in the storage section 21 is output therefrom at a frame rate of M/N in response to the read control signal. Accordingly, when the desired frame rate is N and the frame rate of the original motion image is M, every M/Nth frame of the original motion image is stored in the storage section

For example, when the desired frame rate N is M/2, M/N equals to 2. Accordingly, given that the original image comprises frames of A, B, C, D, E, F, G,H, . . . , every other frames A, C, E, G, . . . may be written into the storage section 21, and then read out at an output terminal of the storage section 21 at the same frame rate as the original motion image. Therefore, as shown in FIG. 4, the preprocessing section 20 outputs the motion image comprising frames A, A, C, C, E, E, G, G, . . . and transmits the same to the compression section 10.

As shown in FIG. 4, the write control signal 2 controls the storage section 22 to receive every other frame of the motion image. The write control signal can be transformed depending on the desired frame rate and generated by the control section 22. Further, there is usually provided a microprocessor or a simple controller in a system for compressing the motion image, so that the write control signal can be applied from the microprocessor or the simple controller instead of the control section 22.

When the preprocessing section 20 outputs the motion image comprising frames of A, A, C, C, E, E, G, G, . . . and the compression section 10 compress the motion image with the same GOP as shown in FIG. 2, compressed data comprising frames I_{A}, P_{A}, P_{C}, P_{C}, I_{E}, P_{E}, P_{G}, P_{G}, . . . is output from the compression section 10.

Of the continuous frames A, A, C, C, E, E, G, G, a subsequent image is substantially similar to a preceding image, respectively. Accordingly, compressed data size of the continuous motion images approximately equals to about zero. That is, even though the original motion image is compressed at a highest frame rate M, it demands a relatively small capacity of a storage medium to store the compressed data because the compressed data comprises frames having a small data size near zero. Therefore, the compressed data dominates least space of the storage medium and the compression section does not have to be modified. In FIG. 4, every other frame in the compressed data has a size near zero.

This method discussed above has an advantage that the motion image compression section is operated at a constant frame rate M without depending on the changed frame rate N. That is, even though the preprocessing section is added before the compression section, the compression section receives the motion image at a frame rate M that is the same frame rate of the original motion image and outputs the compressed image at the same frame rate M. Consequently, the frame rate is changed by down sampling the original motion image before the original motion image is inputted into the compression section at a desired frame rate N.

By the way, in case that this method is applied to a multiple channel input, a plurality of preprocessing sections corresponding to the number of the input are required. Further, the compression section should be provided as much as the number of the input too, and compressed data is produced as much as the same number of the input. Accordingly, a structure of the motion image compression apparatus becomes so complex.

FIG. 5 is a block diagram of a motion image compression apparatus according to another embodiment of the present invention that is suitable for multiple input motion image.

As shown in FIG. 5, the motion image compression apparatus according to the present invention comprises a compression section 10 for receiving original motion image frame by a frame and compressing the received original motion image using the prediction technique, a preprocessing section 20 located at the front end of the compression section for receiving original motion image, changing frame rate of the original motion image to a desired frame rate and sending the original motion image having changed frame rate to the compression section 10, and a multiple image dividing section 30 located at the frond end of the preprocessing section 20 for dividing a multiple input motion image into a plurality of original motion images channel by channel and sending the divided original motion images to the preprocessing section 20.

In the security application field, the multiple input image is usually used to monitor a plurality of places at the same time. Accordingly, the multiple input image is very useful in the security application field. Recently, multiple image input apparatuses receiving 4-channel input, 9-channel input or 16-channel input are commercially used. It is easiest way to process (compress and store) the multiple input image channel by channel. However, a system for processing the multiple input image channel by channel is so complicated.

The multiple image dividing section 30 allows a multiple input image to be stored at the same time like one image after dividing the multiple input image into a plurality of images by switching the multiple input image field by field or frame by frame, or sectioning the multiple input image to a plurality of sections.

The multiple image dividing section 30 is implemented by a commercial multiplexer chip such as AM-209M produced by A-Logics Co. or NVM-1000 produced by Next Chip Co. The apparatus shown in FIG. 5 is provided to respond to the multiple input image with only one compression section 10 by using the multiple image dividing section 30. At this time, it is possible to change all frame rate of the divided original motion images to be the same by manipulating the write control signal frame by frame.

Operation of the motion image compression apparatus shown in accordance with FIG. 5 will be described below.

A multiple input motion image inputted though a plurality of channels at the same time is inputted into the multiple image dividing section 30, and then divided into a plurality of original motion images channel by channel. The divided original motion images are sent to the preprocessing section 20.

The preprocessing section 20 receives the divided original motion images from the multiple image dividing section 30, and then outputs motion images having changed frame rate by changing frame rate of motion images. The motion images having changed frame rate are stored in a storage section 21 channel by channel in response to a write control signal provided by the control section 22, and then sent to the compression section 10 in response to read control signal provided by the control section 22. The compression section compresses the motion images received from the storage section 21 using the prediction technique.

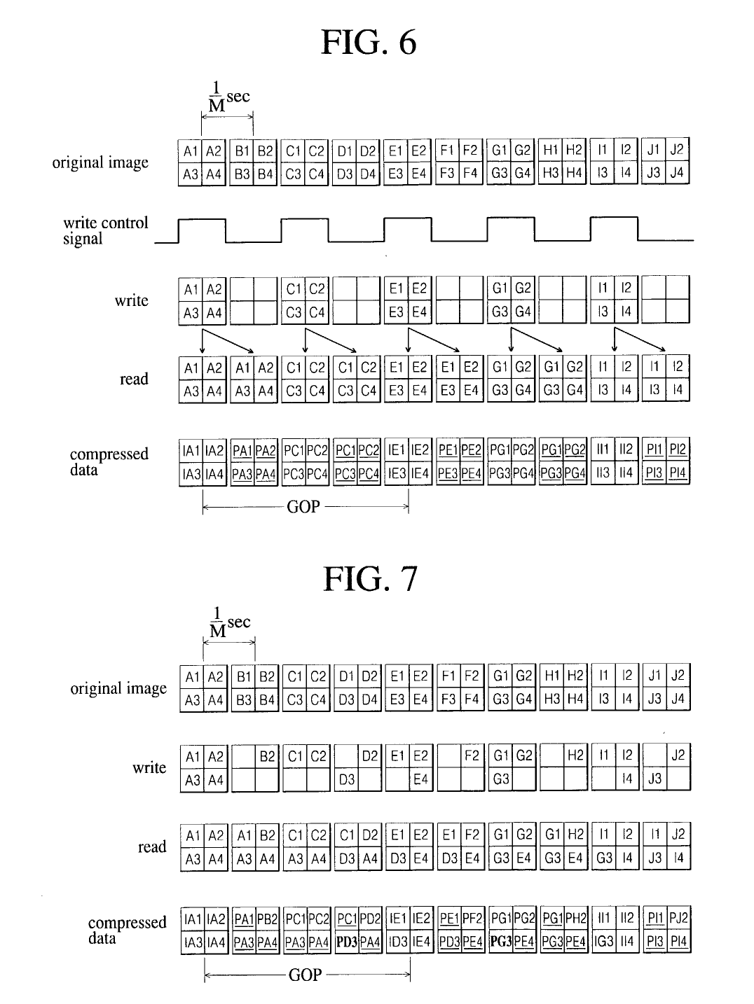

FIG. 6 is showing a sequence of compressing the motion images using the motion image compression apparatus shown in FIG. 5. A multiple input motion image is inputted into the preprocessing section 20 at the same frame rate. The frame rate of the motion images is changed to N that equals to M/2 by the preprocessing section 20.

In comparison with the apparatus of FIG. 4, most operation of the apparatus of FIG. 6 is the same as FIG. 4, except for the motion images are inputted through multiple channels at the same time. As shown in FIG. 6, the motion images are written into the storage section frame by frame. The write control signal can be transformed to control the multiple input motion image section by section which is sectioned by the multiple image dividing section 30. Accordingly, a motion image of each section is independently controlled to have different frame rate.

When a security system monitors a plurality of places at the same time by sectioning one display screen, there are places wherein some are relatively unimportant and others are relatively very important. The relatively important places should be more frequently monitored. For example, bank teller site is relatively important and required more frequently monitored. On the other hand, a rest room in the bank is relatively unimportant place, so that monitoring frequency thereof may be low. Accordingly, it is preferable that the motion images taken in the bank teller site and in the rest room should have different frame rate, thereby being able to effectively manage the security system.

FIG. 7 is showing a sequence of compressing multiple input motion images in which each motion image corresponding to each input channel has a different frame rate from each other. Each attached numeral at right side of each alphabet designate an input channel number on which the motion image is inputted in FIG. 7. As shown in FIG. 7, the motion images are inputted on channel no. 2 and channel no. 1 at frame rates of M and N that equals to M/2, respectively. The motion images are inputted on channel no. 3 and 4 at frame rates of M/3 and M/4, respectively. The write control signal is controlled to respond to each frame rate of the motion images on each channel.

In FIG. 7, the underlined P frames have a data size about zero 0. On the other hand, bold type P frame has a relatively larger data size than the underlined P frames or regular P frames. Such bold type P frames is generated when a GOP is not a multiple of a desired frame rate i.e. changed frame rate. Even though, the bold type P frame has the relatively larger data size, sum of the compressed data size is small. In case that the GOP is 4 and the frame rate to be changed is M/2, M/4 or M/8 (M is a frame rate of original motion image), such Bold type P frames are not generated.

On the other hand, bit rate in the compression section should be varied to store more amount of the compressed data.

The motion image compression standard such as MPEG provides a constant bit rate mode and variable bit rate mode. Therefore, most of chips for use in a image compression system complying with the MPEG standard supports both of the constant bit rate mode and the variable bit rate mode In case of the constant bit rate mode, compressibility is varied for a size of every GOP to meet the constant bit rate by adjusting quantization level. Accordingly, in case of high bit rate, the quantization level is adjusted to be dense so that compressed data size may be increased. To the contrary, in case of low bit rate, the quantization level is adjusted to be coarse so that the compressed data size may be decreased. Therefore, the compressed data size usually will be in a predetermined range. This method has an advantage of being able to predict capacity of demanded storage medium for storing the compressed data while restored image quality is not uniform.

In case of the valuable bit rate mode, the quantization level is fixed, so that restored image quality is uniform. Accordingly, complex image produces a big data size and simple image produces a small data size.

Therefore, in case of using the constant bit rate mode in the image compression apparatus and method thereof in accordance with the present invention, the bit rate should be lowered as frame rate is decreased so that restored image quality is uniform and compressed data size is small. As a result, more longer time of original motion image can be stored in the storage medium as if the motion image is compressed by allocating the low bit rate.

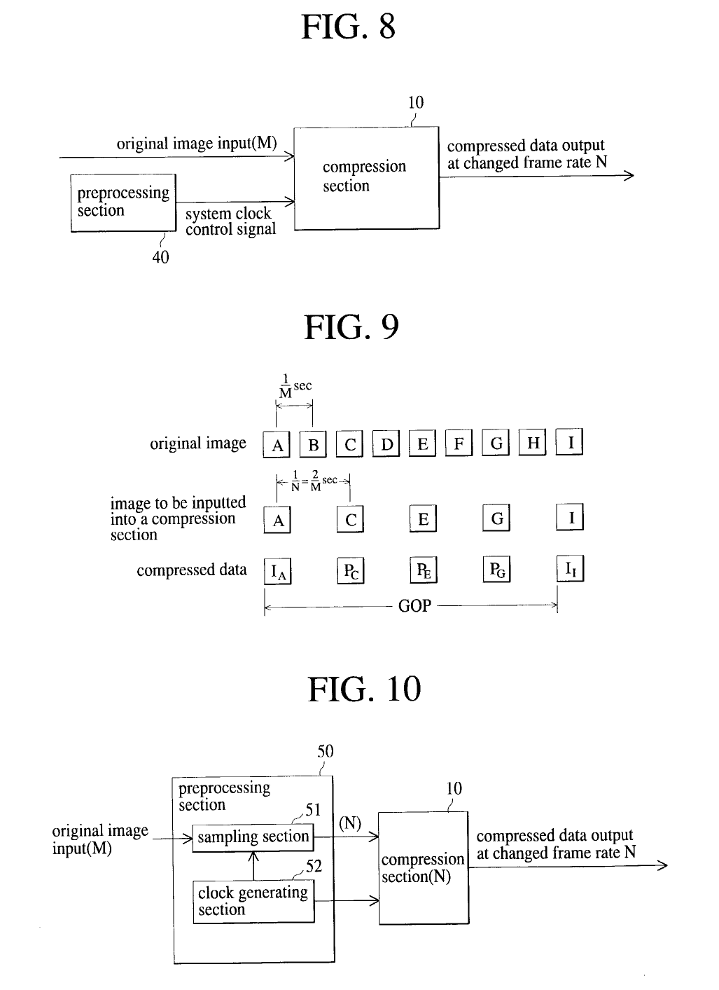

FIG. 8 is a motion image compression apparatus according to further another embodiment of the present invention. As shown in FIG. 8, the motion image compression apparatus comprises a compression section 10 for compressing an original motion image and a preprocessing section 40 for generating a system clock control signal for controlling a system clock of the compression section 10 to change frame rate of the original image to a desired frame rate.

The preprocessing section 40 generates the system clock control signal so that the original motion image is inputted into the compression section 10 as down sampled in response to the system clock control signal.

Accordingly, assuming the original motion image consisting frames A, B, C, D, E, F, G, . . . is inputted into the compression section 10 at the frame rate of M and the desired frame rate is N, a system clock control section of the preprocessing section 40 controls the system control section of the compression section 10 to select one frame from the original motion image at intervals of M/N frames. When the desired frame rate N is M/2, every other frame is selected in response to the system clock control signal generated by the preprocessing section 40.

Accordingly, of the original motion image comprising frames A, B, C, D, E, F, G, . . . , only every other frame such as A, C, E, G, . . . are inputted into the compression section 10 as shown in FIG. 9. When the frame rate of the original motion image is M and the desired frame rate N is M/2, the frame rate of the motion images changed to 2 so that the compression section 10 outputs compressed data comprising I_{A}, P_{C}, P_{E}, P_{G} . . . at the changed frame rate of N i.e. 2.

In comparison with FIG. 4, the original motion image E becomes I frame I_{E} in FIG. 4 while the original motion image I becomes I frame Ii, but other elements are not different between FIG. 4 and FIG. 9. That is, when the GOP structure is the same, the compression section is operated at the changed frame rate N and the compressed image data is output from the compression section at the same frame rate N. In FIG. 4, when the GOP comprises one I frame and seven P frames and the desired frame rate N is M/2, the compressed data in FIG. 4 will be the same as the compressed data of FIG. 9. However, the frame rate is different. The compression section is operated at a frame rate M in FIG. 4 but at a frame N in FIG. 9.

FIG. 10 is a block diagram of the motion image compression apparatus capable of changing frame rate in accordance with further another embodiment of the present invention. The motion image compression apparatus comprises a preprocessing section 50 for receiving an original motion image at a frame rate and outputting the original motion image at a changed frame rate by down sampling the original motion image, and a compression section 10 for receiving the original motion image down sampled and compressing the down sampled original motion image.

The preprocessing section 50 comprises a sampling section 51 and a clock generating section 52 for providing a clock to the sampling section 51. When a desired frame rate is N for the original motion image comprising frames of A, B, C, D, . . . , the original motion image is down sampled at intervals of M/N frames in response to a system clock generated by the clock generating section 52. Accordingly, when the desired frame rate N is M/2, the original motion image is down sampled at an interval of two frames.

The compression section 10 receives the down sampled motion image consisting frames of A, C, E, G, . . . from the preprocessing section 50, and outputs compressed data comprising frames of I_{A}, P_{C}, P_{E}, P_{G} by compressing the down sampled motion image. In the apparatus of FIG. 10, the original image is inputted into the compression section 10 at a frame rate of N, while the original image is inputted at a frame rate of M in the apparatus shown in FIG. 8.

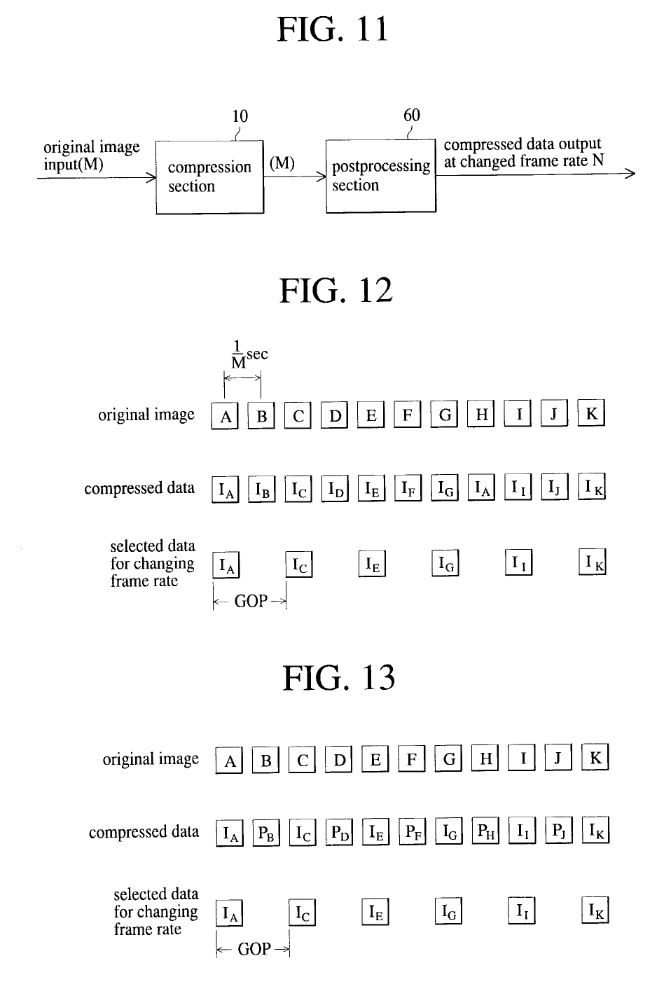

FIG. 11 is a block diagram of a motion image compression apparatus in accordance with still another embodiment of the present invention, and FIG. 12 is showing a sequence of compressing a motion image using intra frame method in the apparatus of FIG. 11. As shown in FIG. 11, the motion image compression apparatus of the present invention comprises a compression section 10 and a postprocessing section 60 for changing frame rate by deleting selected frames from compressed image output from the compression section 10.

The postprocessing section 60 includes a selector for selecting frames to be deleted.

Accordingly, when the original image comprising frames A, B, C, D, E, F, G, . . . is inputted into the compression section 10 at a frame rate of M, the compression section 10 compresses the original image and outputs a compressed data comprising a plurality of I frames of I_{A}, I_{B}, I_{C}, I_{D}, I_{E}, I_{F}, I_{G}, . . . Then, the postprocessing section 60 deletes the M/N-1 frames at an interval of M/N frames in which N is a desired frame rate.

Therefore, the frame rate of the compressed image is changed to N as shown in FIG. 12.

FIG. 13 is showing a sequence of compressing a motion image using inter frame and intra frame in the apparatus of FIG. 11. As shown in FIG. 13, P frames of P_{B}, P_{D}, P_{F}, P_{H}, . . . are allocated instead of the deleted I frames I_{B}, I_{D}, I_{F}, I_{H}, . . . in FIG. 12, respectively because the compressed data including both of intra frame and inter frame can not be restored without a preceding frame thereof. In FIG. 13, the GOP comprises I frames and P frames with a ratio of 1:1.

The method of FIG. 12 can overload the compression section because all frames are compressed in a format of I frame. Accordingly, it is preferable to adequately change the GOP so that the P frame is allocated to the frames to be deleted by the postprocessing section. As a result, the frame rate is effectively changed without overburdening the compression section. That is, the GOP is varied to be M/N when the frame rate of the original motion image is M and a desired frame is N. Therefore, when the desired frame rate is M/2, the GOP (M/N) becomes 2.

In the drawings, operation clock and control signals for changing variable frame rate are not depicted but the same will be easily understood by the person ordinary skilled in the art.

Various other modifications will be apparent to and can be readily made by those skilled in the art without departing from the scope and spirit of this invention. Accordingly, it is not intended that the scope of the claims appended hereto be limited to the description as set forth herein, but rather than the claims be broadly constructed.

What is claimed is:

1. A Motion image compression apparatus capable of changing frame rate, comprising:
a compression section for compressing motion images using a prediction technique after receiving the motion images frame by frame; and
a preprocessing section located at a front end of the compression section for receiving original motion images, changing a frame rate of the original motion images to a desired frame rate and sending the motion images having the desired frame rate to the compression section frame by frame.

2. The motion image compression apparatus capable of changing frame rate according to claim 1, wherein the preprocessing section comprises:
a storage section for temporalily storing the original motion image after receiving the same; and
a control section for generating a write control signal and a read control signal, wherein the write control signal is used to store the original motion images frame by frame into the storage section after down sampling the original motion images at intervals of a predetermined time period which corresponds to a desired frame rate, and the read control signal is used to read the original motion image stored in the storage section frame by frame at intervals of a predetermined time period which corresponds to the frame rate of the original motion image and send the same to the compression section.

3. The motion image compression apparatus capable of changing frame rate according to claim 1, wherein the preprocessing section comprises:
a clock generating section for generating a clock signal; and
a sampling section for down sampling the original motion images in response to the clock signal after receiving the original motion images, and sending the down sampled motion images to the compression section.

4. The motion image compression apparatus capable of changing frame rate according to claim 1, further comprising a multiple image dividing section located at the front end of the preprocessing section for dividing a multiple input motion image into a plurality of original motion images channel by channel and sending the divided original motion images to the preprocessing section when the multiple input motion image is received therein.

5. The motion image compression apparatus capable of changing frame rate according to claim 4, wherein the preprocessing section comprises:
a storage section for receiving the divided original motion images output from the multiple image dividing section and temporality storing the divided original motion images; and
a control section for generating a write control signal and a read control signal, wherein the write control signal is used to store the divided original motion images on each channel frame by frame into the storage section after down sampling the divided original motion images at intervals of a time period which corresponds to a desired frame rate, and the read control signal is used to read the divided original motion images stored in the storage section frame by frame at intervals of a predetermined time period which corresponds to the frame rate of the original motion image and send the same to the compression section.

6. The motion image compression apparatus capable of changing frame rate according to claim 5, wherein the write control signal comprises a single signal, so that the frame rate of the motion images on every channel is the same.

7. The motion image compression apparatus capable of changing frame rate according to claim 5, wherein the write control signal comprises more than one signal, each having a different frequency and corresponding to each channel, so that the frame rates of the motion images on every channel are different with respect to each other.

8. The motion image compression apparatus capable of changing frame rate according to claim 1, comprising the use of a constant bit rate, wherein the bit rate is varied proportionately to the frame rate.

9. A motion image compression apparatus capable of changing frame rate, comprising:
a compression section for receiving original motion image frame by frame and compressing the original motion image using a prediction technique; and
a preprocessing section located at a front end of the compression section for controlling a system clock of the compression section so that the original motion image is down sampled at a desired frame rate and then the down sampled image is inputted into the compression section when the original moving information is inputted into the compression section frame by frame.

10. A motion image compression apparatus capable of changing frame rate, comprising:
a compression section for receiving original motion image frame by frame and outputing compressed data after compressing the original motion image; and
a postprocessing section located at a back end of the compression section for changing a frame rate of the original motion image by deleting a selected frame from the compressed data at a certen interval and storing image having a changed frame rate therein when the compressed data is output from the compression section frame by frame.

11. The motion image compression apparatus capable of changing frame rate according to claim 10, wherein the compression section compresses the original motion image using an intra frame method, wherein a selected intraframe is deleted by the postprocessing section.

12. The motion image compression apparatus capable of changing frame rate according to claim 10, wherein the compressed data includes intra frames and inter frames, and GOP is set so that a selected inter frame is deleted in the postprocessing section.

13. A method of compressing motion image capable of changing frame rate, comprising:
preprocessing original motion image for outputing the original motion image frame by frame after changing frame rate of the original motion image to a desired frame rate; and
compressing motion image having the desired frame rate frame by frame using a prediction technique.

14. The method according to claim 13, wherein the preprocessing comprises:
downsampling the original motion image at intervals of a predetermined time which corresponds to the desired frame rate and storing down sampled motion image into a storage medium; and
reading the down sampled motion image stored in the storage medium at intervals of a predetermined time which corresponds to the frame rate of the original motion image frame by frame and outputing the same for being compressed.

15. The method according to claim 13, wherein the preprocessing comprises:
downsampling the original motion image at intervals of a predetermined time which corresponds to the desired frame rate and outputing the same for being compressed.

16. The method according to claim 13, further comprising:
dividing a multiple motion image into a plurality of original motion images channel by channel and outputing divided original motion images when the multiple motion image is inputted as the original motion image.

17. The method according to claim 16, wherein the preprocessing comprises:
downsampling the divided original motion images channel by channel at intervals of a predetermined time which corresponds to the desired frame rate in response to a write control signal and storing down sampled divided original motion images into a storage medium; and
reading the down sampled divided original motion images stored in the storage medium at intervals of a predetermined time which corresponds to the frame rate of the original motion image on each channel frame by frame and outputing the images read out from the storage medium for being compressed.

18. The method according to claim 17, wherein the write control signal comprises a single signal having a frequency so that the images on every channel has the same frame rate.

19. The method according to claim 17, wherein the write control signal comprises more than one signal each having a different frequency so that frame rate on each channel is different.

20. A method of compressing a motion image capable of changing frame rate, comprising:
generating a control signal for controlling a clock signal which is used for receiving the motion image to be compressed;
downsampling the motion image in response to the clock signal at a desired frame rate when the motion image is inputted; and
compressing the down sampled motion image and outputting compressed data.

21. A method of compressing a motion image capable of changing frame rate, comprising:
receiving an original motion image frame by frame and compressing the original motion image, whereby outputing compressed data frame by frame; and
postprocessing the compressed data, wherein the postprocessing includes changing frame rate of the compressed data by deleting a selected frame out of the compressed data.

22. The method according to claim 21, wherein the compressing the original motion image comprises an inter frame method so that an inter frame is deleted during the deleting.

23. The method according to claim 21, wherein the compressed data comprises intra frames and inter frames so that the interframe is deleted during the deleting.
